(19) United States
(12) Patent Application Publication
(10) Pub. No.: US 2009/0226719 A1
(43) Pub. Date: Sep. 10, 2009

(54) COMPOSITE MATERIAL FORMULATION

(76) Inventor: SARA MOLINA, Big Spring, TX (US)

Correspondence Address: WONG, CABELLO, LUTSCH, RUTHERFORD & BRUCCULERI,;L.L.P., 20333 SH 249 6th Floor, HOUSTON, TX, 77070, US

(21) Appl. No.: 12/398,029

(22) Filed: Mar. 4, 2009

Related U.S. Application Data
(60) Provisional application No. 61/034,039, filed on Mar. 5, 2008.

(51) Int. Cl. B32B 1/00; B05D 3/02; B32B 37/02

(52) U.S. Cl. 428/367; 428/364; 427/386; 156/169; 156/180

(57) ABSTRACT

A system according to the present invention may be comprised of an epoxy resin, hardener and catalyst. One particular preferred system ratio is 1:1.64:0.005, respectively. The epoxy resin may be a tetrafunctional resin. The hardner may be a nadic methyl anhydride. One particularly preferred heat activated catalyst is 1-(2-hydroxypropyl) imidazole available from the Lindau Company under the brand name LINDAX 1. The amount of catalyst may be tailored to a certain desired pot life, oven cure and to promote polymer crosslinking at a faster rate. The system is particularly advantageous in the fabrication of composite bridge plugs.

### CROSS-REFERENCE TO RELATED APPLICATIONS

This application claims the benefit of U.S. Provisional Application No. 61/034,039, filed Mar. 5, 2008.

### STATEMENT REGARDING FEDERALLY SPONSORED RESEARCH OR DEVELOPMENT

Not Applicable

### BACKGROUND OF THE INVENTION

1. Field of the Invention

This invention relates to composite materials. More particularly it relates to fiber-reinforced epoxy resins.

2. Description of the Related Art including information disclosed under 37 CFR 1.97 and 1.98.

Curable resinous compositions are described in international application WO 2006/052253 published under the Patent Cooperation Treaty. The curable composition described in that patent publication may be hardened in the presence of a heat activated catalyst to render a scratch resistant hard surface.

Organometallic compositions and coating compositions are described in international application WO 2006/022899 published under the Patent Cooperation Treaty. Certain catalysts described therein include organometallic compositions according to the formula Metal(Amidine)₂(Carboxylate)ₓ where x is the oxidation state of the metal. Examples include Zn(Lindax-1)₂(acetate)₂, Zn(Lindax-1)₂(formate)₂ and Zn(Lindax-1)₂(2-ethylhexanoate)₂ where Lindax-1 supplied by Lindau Chemicals Inc. is 1-(2-hydroxypropyl)imidazole.

### BRIEF SUMMARY OF THE INVENTION

The system according to the present invention may be comprised of an epoxy resin, hardener and catalyst. One particular preferred system ratio is 1:1.64:0.005, respectively. The epoxy resin may be a tetrafunctional resin. The hardener may be a nadic methyl anhydride. One particularly preferred heat activated catalyst is 1-(2-hydroxypropyl) imidazole available from Lindau Chemicals, Inc. (Columbia, S.C.) under the brand name LINDAX 1. The amount of catalyst may be tailored to a certain desired pot life, oven cure and to promote polymer crosslinking at a faster rate.

### BRIEF DESCRIPTION OF THE SEVERAL VIEWS OF THE DRAWING(S)

FIG. 1 is a differential scanning calorimeter (DSC) plot for a sample having a cure schedule of 11 hours at 140° F., 2 hours at 302° F. and 5 hours at 425° F.

FIG. 2 is a differential scanning calorimeter (DSC) plot for a sample having a cure schedule of 13 hours at 140° F., 2 hours at 302° F. and 5 hours at 425° F.

FIG. 3 is a differential thermo-mechanical analyzer plot of a sample prepared using a final cure period temperature of 425° F.

FIG. 4 is a differential scanning calorimeter plot for a sample cured at a final temperature of 425° F.

FIG. 5 is a differential scanning calorimeter plot for a sample cured at a final temperature of 450° F.

FIG. 6 is a differential scanning calorimeter plot for a sample cured at a final temperature of 475° F.

FIG. 7 is a differential thermo-mechanical analyzer plot of a sample prepared using a final cure period temperature of 325° F.

FIG. 8 is a thermo gravimetric analyzer plot for uncured material impregnated with resin and pulled through an orifice having a diameter of 0.054 inch.

FIG. 9 is a thermo gravimetric analyzer plot for uncured material impregnated with resin and pulled through an orifice having a diameter of 0.064 inch.

### DETAILED DESCRIPTION OF THE INVENTION

A composite is a mixture or mechanical combination on a macro scale of two or more materials that are solid in the finished state, are mutually insoluble, and differ in chemical nature. One major type of composite material is reinforced plastics, principally comprised of glass fiber and a thermosetting resin. Other types of fibers such as carbon, boron, aluminum silicate, and silicon carbide may be used.

A composite system according to the present invention may be comprised of an epoxy resin, hardener and catalyst. One particular preferred system ratio is 1:1.64:0.005 respectively. The epoxy resin may be a tetrafunctional resin. The hardener may be a nadic methyl anhydride. One particularly preferred heat-activated catalyst is 1-(2-hydroxypropyl) imidazole available from the Lindau Company under the brand name LINDAX 1.

The amount of catalyst may be tailored to the desired pot life, oven cure and to promote polymer crosslinking at a faster rate. In a preferred embodiment, fiberglass rovings are impregnated with this resin system as the filament winding process takes place. During filament winding, the pot containing the resin mixture is preferably maintained at a temperature of about 110° F. to promote the flow of the system to better impregnate the fiberglass strands. Once the winding process is complete and the tubing has been fabricated, the system is cured at 140° F. for 12 hours, 302° F. for 2 hours and 425° F. for 5 hours. The process is then substantially complete.

One aspect of this new solution which differentiates it from prior solutions is the catalyst. Epoxy resin systems are usually two part systems, additives may be incorporated into the system to give the epoxy one or more special characteristics. In this system, the catalyst and the amount are critical. The catalyst in this case provides a faster cure, promoting a higher amount of crosslinking thereby enabling the product to have a higher glass transition temperature allowing it to be exposed to extreme environments where high temperatures and pressures are involved.

Table 1, below, shows the onset glass transition temperature (T_{g}) for various tested systems as determined by thermomechanical analysis using an expansion probe. The sample thickness is also shown in the table. The weight percent catalyst for Sample Nos. 3, 4 and 5 were 0.1, 1.0 and 0.5, respectively. Sample Nos. 1 and 2 represent resin/hardener systems of the prior art. Sample No. 5 represents the currently preferred system.

TABLE 1

| | Sample ID | | | | |
|---|---|---|---|---|---|
| | CY179/L25 | L290/25 | 721/25/0.1 | 721/25/1.0 | 721/25/0.5 |
| | Sample No. | | | | |
| | 1 | 2 | 3 | 4 | 5 |
| Thick- | 3.77 mm | 1.40 mm | 2.77 mm | 2.04 mm | 3.03 mm |
| ness | | | | | |
| Onset | 218.0° C. | 223.0° C. | 204.0° C. | 223.4° C. | 295.0° C. |
| Temp | | | | | |

Table 2, below, shows the transition temperatures of various resin/hardener systems without a catalyst. MY721/A5200 is a resin/hardener system from Huntsman Corporation (Basel, Switzerland) that utilizes an amine-based hardener. MY721/A917 is another resin/hardener system from Huntsman Corporation that utilizes an amine-based hardener. “Pure G-14” is an epoxy resin system of the prior art that has an anhydride-based hardener. “Blend G-13” is a bis A epoxy system having a cyclo aliphatic hardener.

TABLE 2

| | Transition | Transition | |
|---|---|---|---|
| Resin/Hardener | 1° C. | 2° C. | |
| (ratio) | (° F.) | (° F.) | Observation |
| Lindoxy | 192.6 | Not | Transition 1 is strong so it can |
| 190/Lindride 25 | (378.7) | observed | be considered the T_{g} |
| (1:1.25) | | | |
| Lindoxy | 219.5 | Not | Transition 1 is strong so it can |
| 290/Lindride 25 | (427.1) | observed | be considered the T_{g}. Other |
| (1:1) | | | transitions too small to take into |
| | | | account. |
| MY721/A5200 | 204.3 | Not | Transition 1 is strong so it can |
| (1:0.40) | (399.7) | observed | be considered the T_{g}. |
| | | | Unlike 10/30 samples, only one |
| | | | clear transition observed. |
| MY721/A917 | 217.2 | Not | Unlike 10/30 sample, sample |
| (1:1.41) | (423.0) | observed | showed lower amount of un- |
| | | | cured material on only one clear |
| | | | transition. |
| MY721/Lindride | 220.8 | Not | Shows a unique transition and |
| 25 | (429.4) | observed | almost 20° F. higher as compared |
| (1:1.64) | | | to sample with only 0.4 ratio of |
| | | | Lindride 25 |
| Pure G-14 | 217.1 | Not | Transition 1 is strong so it can |
| | (422.8) | observed | be considered the T_{g} |
| Blend G-13 | 216.4 | Not | Transition 1 is strong so it can |
| | (421.5) | observed | be considered the T_{g} |

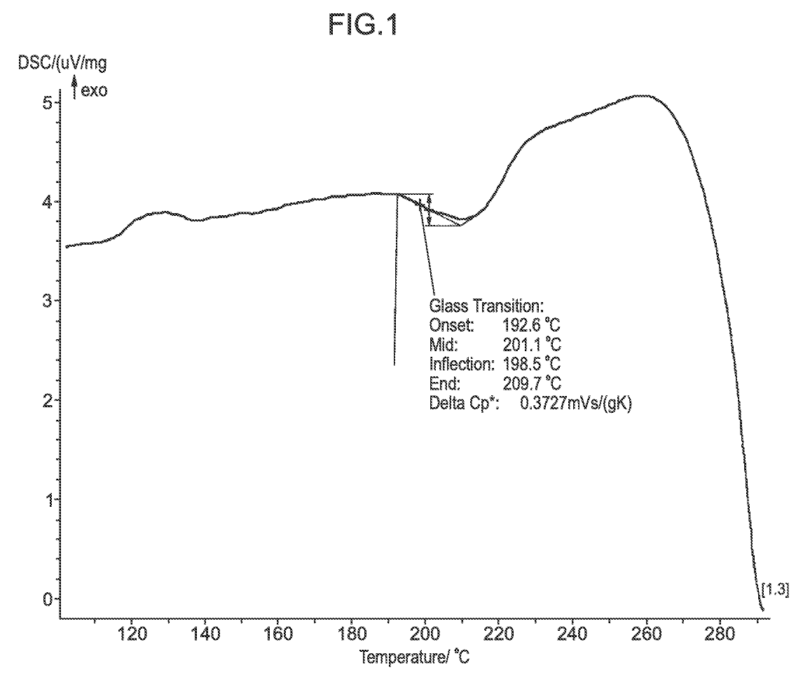

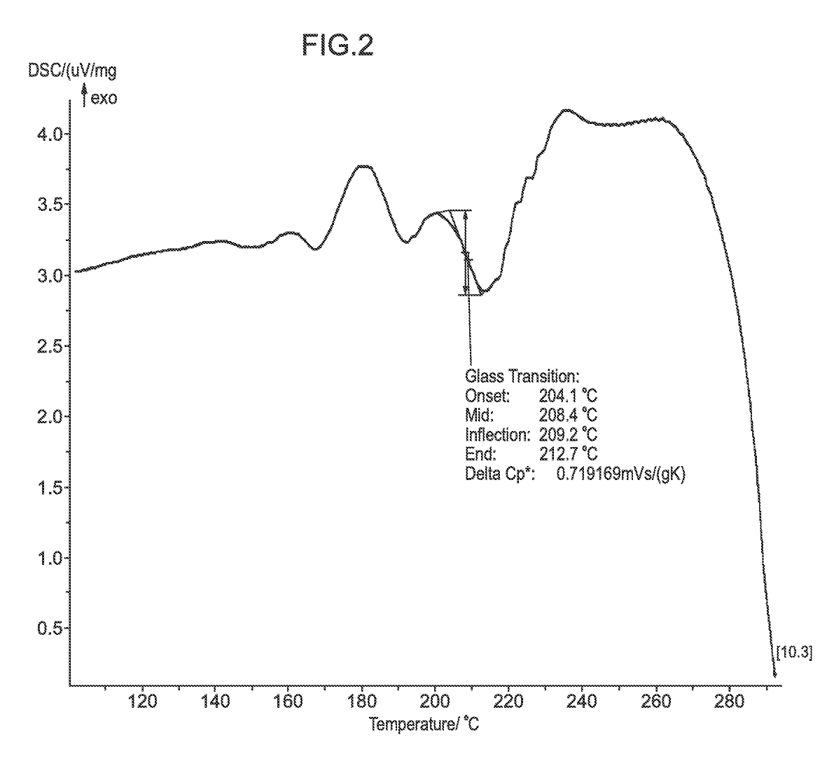

Samples having differing initial cure times are compared in FIGS. 1 and 2. The sample of FIG. 1 had a cure schedule of 11 hours at 140° F., 2 hours at 302° F. and 5 hours at 425° F. The sample of FIG. 2 had a cure schedule of 13 hours at 140° F., 2 hours at 302° F. and 5 hours at 425° F.

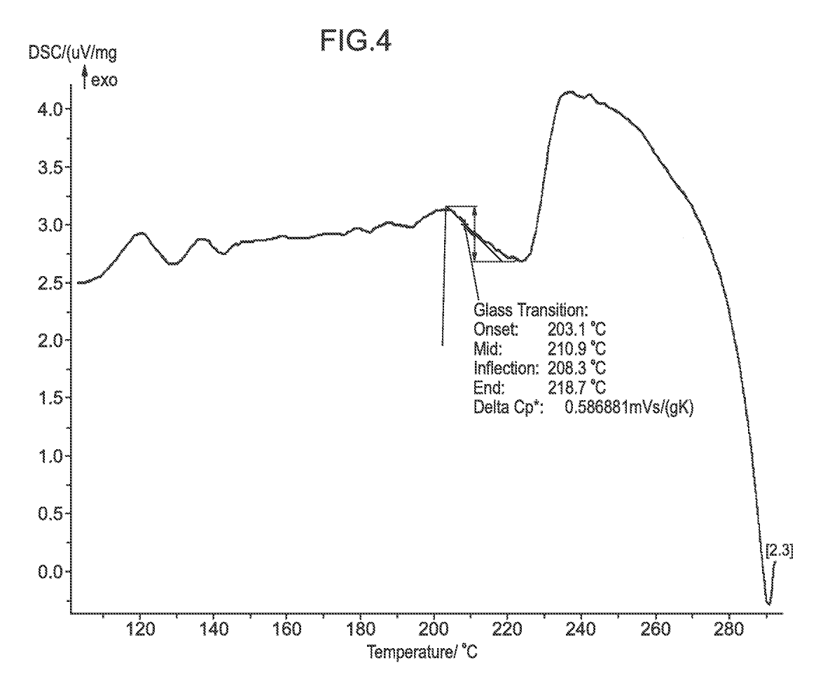

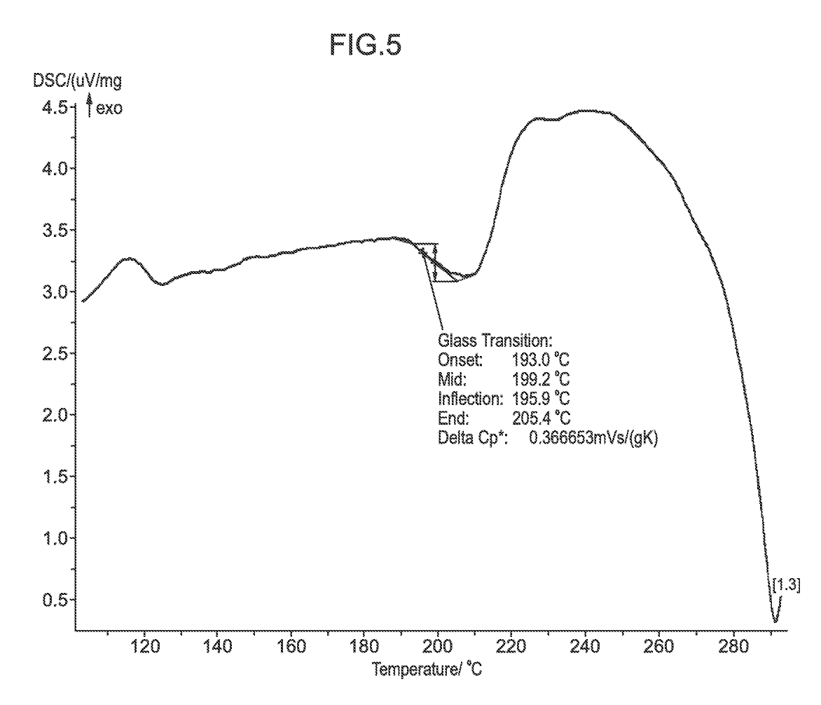

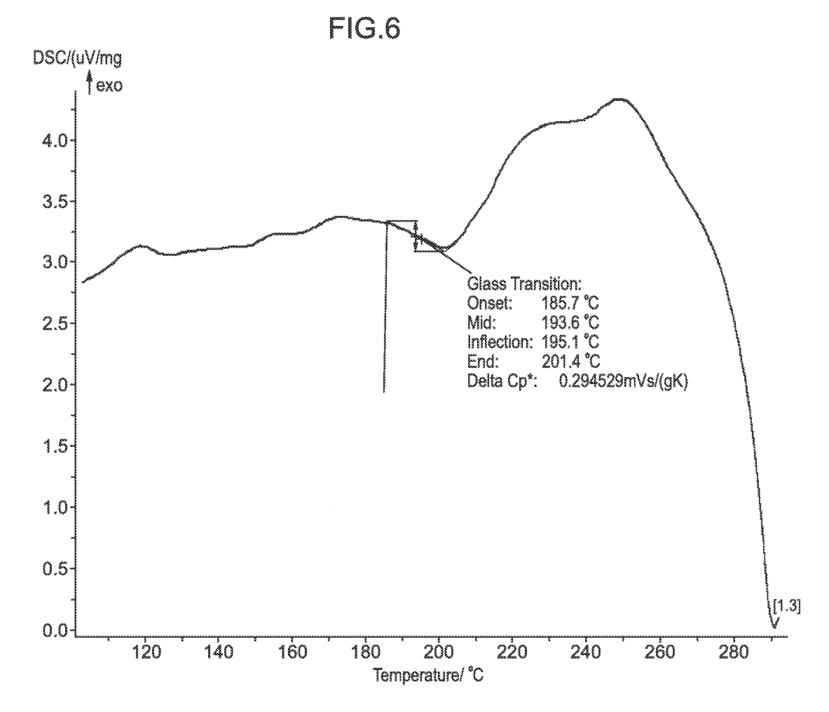

Samples having differing final cure temperatures are compared in FIGS. 4, 5 and 6. The sample of FIG. 4 was cured at a final temperature of 425° F. The sample of FIG. 5 was cured at a final temperature of 450° F. The sample of FIG. 6 was cured at a final temperature of 475° F.

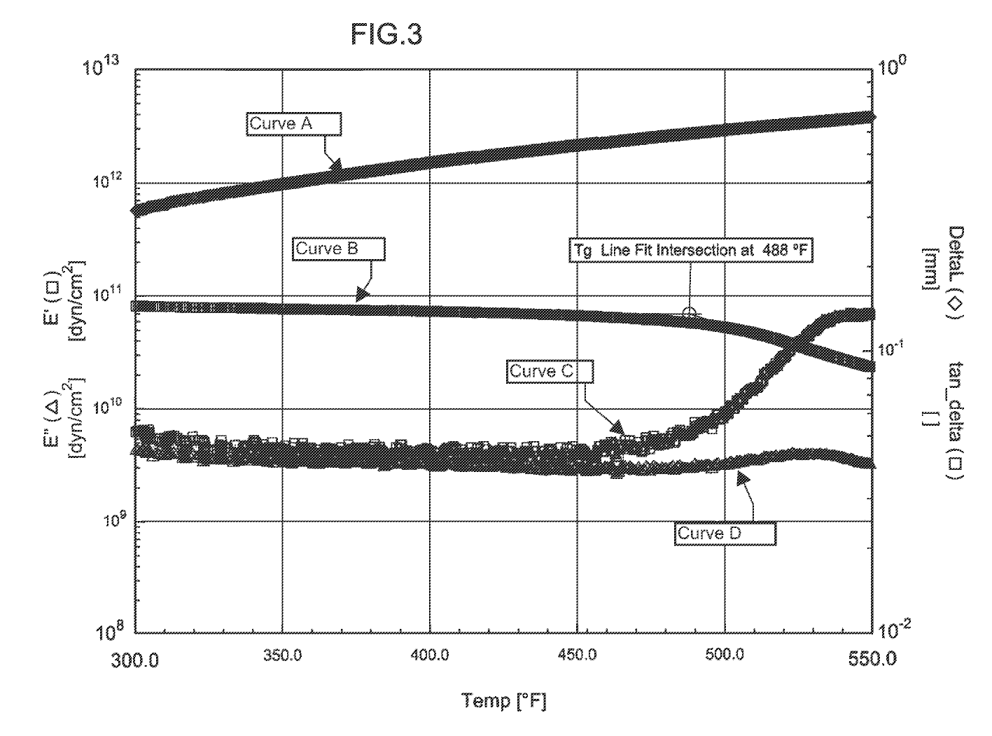

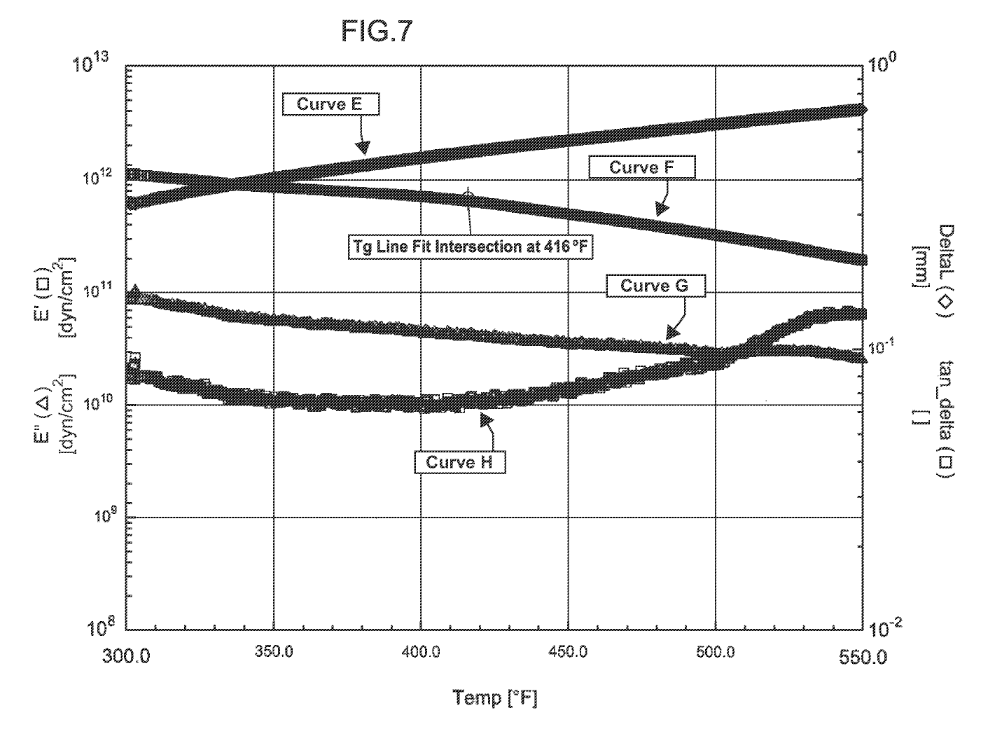

The glass transition temperature of an organic polymer may be determined by differential scanning calorimetry (or DSC), a thermoanalytical technique in which the difference in the amount of heat required to increase the temperature of a sample and reference are measured as a function of temperature. FIGS. 1, 2, 4, 5 and 6 are DSC plots. Another technique for determining T_{g} is differential thermo-mechanical analysis. FIGS. 3 and 7 are differential thermo-mechanical analyzer plots of selected samples.

In FIG. 3, Curve B is E′ in dynes per cm², Curve D is E″ in dynes per cm², Curve A is delta L in millimeters and Curve D is tangent delta. In FIG. 7, Curve F is E′ in dynes per cm², Curve G is E″ in dynes per cm², Curve E is delta L in millimeters and Curve H is tangent delta. Lines A and E on the charts depicted in FIGS. 3 and 7, respectively, represent the coefficient of linear expansion. Lines B and F represent E′, the elastic or storage component of the complex modulus E*. Lines D and G represent E″, the viscous or loss component of the complex modulus. E′ and E″ are related to the complex modulus by the Pythagorean theorem: (E*)E²=(E′)E²+(E″)E². Lines C and H are the tangent of delta, (tan δ), which is E″/E′. It is a measure of elasticity. By way of example, tire treads have a low tan δ, about 0.25, while butyl shock absorbers have a high tan δ. The peak in the tan delta line can be interpreted as the glass transition. The T_{g} can be interpreted from either the E′ or E″ curve using the intersection of slopes. This may be advantageous when the tangent delta peak is not very clear or occurs out of the test range. In the charts reproduced in FIGS. 3 and 7, the slope intersects of E′ where used since the peak of tan delta occurs to the far right of, or off the chart. Both the glass transition, and the stability of E′ and E″ over the tested temperature range are figures of merit for the material tested.

Another aspect of the invention is the processing and the cure schedule. Filament winding with a tetrafunctional epoxy resin is unique in itself due to the epoxy's viscosity.

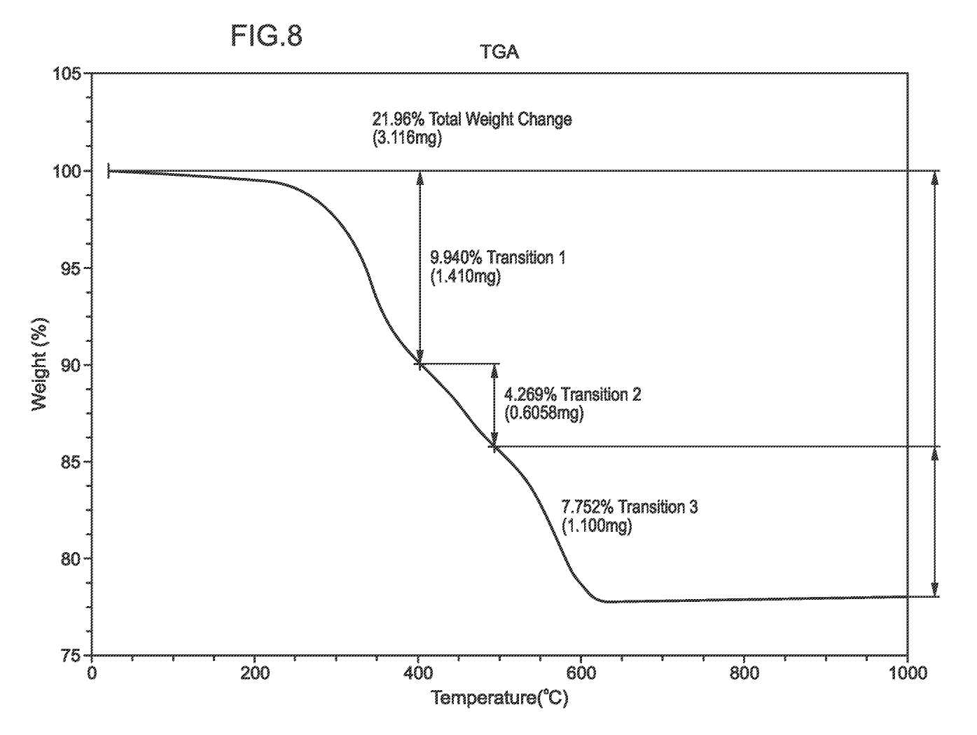

For one, particular preferred embodiment, a resin-impregnated fiber will have between about 30% and about 35% resin, by weight, in the “wet” condition—i.e., prior to curing. FIG. 8 is a thermo gravimetric analyzer plot for material impregnated with resin and pulled through an orifice having a diameter of 0.054 inch. The sample size was 14.1890 mg. A nitrogen purge was used as the temperature was ramped from room temperature to 600° C. An air purge was used from 600 to 1000° C.

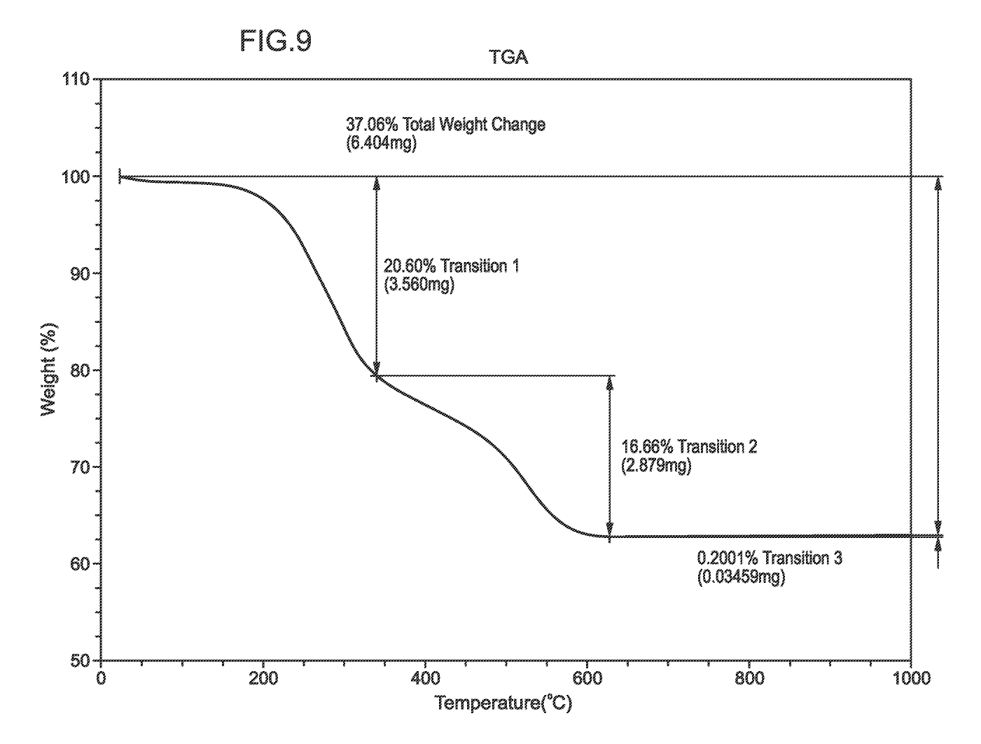

FIG. 9 is a thermo gravimetric analyzer plot for material impregnated with resin and pulled through an orifice having a diameter of 0.064 inch. The sample size was 17.2820 mg. A nitrogen purge was used as the temperature was ramped from room temperature to 600° C. An air purge was used from 600 to 1000° C. It can be seen that the 0.064 inch diameter orifice (or “nib”) comes closer to producing material in the desired range of about 30 to 35% resin.

One particular application of the method of the invention is the production of composite bridge plugs. A bridge plug is a downhole tool that is located and set to isolate the lower part of a wellbore. Bridge plugs may be permanent or retrievable, enabling the lower wellbore to be permanently sealed from production or temporarily isolated from a treatment conducted on an upper zone. Often, bridge plugs are removed from a well bore by drilling them out. Bridge plugs fabricated predominately from steel or similar hard metals are difficult to drill out, often requiring several replacements of the drill bit during the removal operation. Bridge plugs fabricated using synthetic polymer materials are relatively easy to remove by drilling, but frequently lack the strength required to obtain a reliable set. It has been found that a bridge plug fabricated using fiberglass impregnated with a resin composition according to the present invention, wound on a mandrel and cured as hereinabove described has the requisite strength but can easily be drilled out of the wellbore after it has been set.

Although the invention has been described in detail with reference to certain preferred embodiments, variations and modifications exist within the scope and spirit of the invention as described and defined in the following claims.

What is claimed is:

1. A composite article prepared by the process comprising the steps of:
coating a fiber with a mixture comprising one part tetrafunctional epoxy resin, about 1.64 parts nadic methyl anhydride hardener and about 0.005 part 1-(2-hydroxypropyl) imidazole catalyst; and,
curing the coated fiber at about 140° F. for about 12 hours, followed by curing at about 302° F. for about 2 hours, followed by curing at about 425° F. for about 5 hours.

2. A composite article as recited in claim 1 wherein the fiber is a glass fiber.

3. A composite article as recited in claim 1 wherein the fiber is a carbon fiber.

4. A composite article as recited in claim 1 wherein the fiber is an synthetic polymer fiber.

5. A composite article as recited in claim 1 wherein the fiber is an aramid fiber.

6. A composite article prepared by the process comprising the steps of:
impregnating a fiber roving with a mixture comprising one part tetrafunctional epoxy resin, about 1.64 parts nadic methyl anhydride hardener and about 0.005 part 1-(2-hydroxypropyl) imidazole catalyst;
forming the impregnated roving into a selected shape; and,
curing the formed, impregnated roving at about 140° F. for about 12 hours, followed by curing at about 302° F. for about 2 hours, followed by curing at about 425° F. for about 5 hours.

7. A composite article as recited in claim 6 wherein the fiber is a glass fiber.

8. A composite article as recited in claim 6 wherein the fiber is a carbon fiber.

9. A composite article as recited in claim 6 wherein the fiber is an synthetic polymer fiber.

10. A composite article as recited in claim 6 wherein the fiber is an aramid fiber.

11. A composite article as recited in claim 6 wherein the step of forming comprises molding.

12. A composite article as recited in claim 6 wherein the step of forming comprises winding.

13. A composite article as recited in claim 6 wherein the step of forming comprises layering.

14. A composite bridge plug prepared by the process comprising the steps of:
impregnating a fiberglass roving with a mixture comprising one part tetrafunctional epoxy resin, about 1.64 parts nadic methyl anhydride hardener and about 0.005 part 1-(2-hydroxypropyl) imidazole catalyst;
winding the impregnated roving into a generally cylindrical shape; and,
curing the wound, impregnated roving at about 140° F. for about 12 hours, followed by curing at about 302° F. for about 2 hours, followed by curing at about 425° F. for about 5 hours.

15. A composite bridge plug as recited in claim 14 wherein the impregnated roving is wound on a mandrel.

16. A composite bridge plug as recited in claim 15 prepared by a process further comprising pulling the mandrel out of the generally cylindrical shape after curing.

17. A method for forming a composite article comprising the steps of:
coating a fiber with a mixture comprising one part tetrafunctional epoxy resin, about 1.64 parts nadic methyl anhydride hardener and about 0.005 part 1-(2-hydroxypropyl) imidazole catalyst; and,
curing the coated fiber at about 140° F. for about 12 hours, followed by curing at about 302° F. for about 2 hours, followed by curing at about 425° F. for about 5 hours.

18. A method as recited in claim 17 wherein the fiber is a glass fiber.

19. A method as recited in claim 17 wherein the fiber is a carbon fiber.

20. A method as recited in claim 17 wherein the fiber is an synthetic polymer fiber.

21. A method as recited in claim 17 wherein the fiber is an aramid fiber.

22. A method for forming a composite article comprising the steps of:
impregnating a fiber roving with a mixture comprising one part tetrafunctional epoxy resin, about 1.64 parts nadic methyl anhydride hardener and about 0.005 part 1-(2-hydroxypropyl) imidazole catalyst;
forming the impregnated roving into a selected shape; and,
curing the formed, impregnated roving at about 140° F. for about 12 hours, followed by curing at about 302° F. for about 2 hours, followed by curing at about 425° F. for about 5 hours.

23. A method as recited in claim 22 wherein the fiber is a glass fiber.

24. A method as recited in claim 22 wherein the fiber is a carbon fiber.

25. A method as recited in claim 22 wherein the fiber is an synthetic polymer fiber.

26. A method as recited in claim 22 wherein the fiber is an aramid fiber.

27. A method as recited in claim 22 wherein the step of forming comprises molding.

28. A method as recited in claim 22 wherein the step of forming comprises winding.

29. A method as recited in claim 22 wherein the step of forming comprises layering.

30. A method for forming a composite bridge plug comprising the steps of:
impregnating a fiberglass roving with a mixture comprising one part tetrafunctional epoxy resin, about 1.64 parts nadic methyl anhydride hardener and about 0.005 part 1-(2-hydroxypropyl) imidazole catalyst;
winding the impregnated roving into a generally cylindrical shape; and,
curing the wound, impregnated roving at about 140° F. for about 12 hours, followed by curing at about 302° F. for about 2 hours, followed by curing at about 425° F. for about 5 hours.

31. A method as recited in claim 30 wherein the impregnated roving is wound on a mandrel.

32. A method as recited in claim 30 further comprising pulling the mandrel out of the generally cylindrical shape after curing.
